(19) United States
(12) Patent Application Publication
(10) Pub. No.: US 2015/0015613 A1
(43) Pub. Date: Jan. 15, 2015

(54) DATA PROCESSING DEVICE AND DATA PROCESSING SYSTEM

(71) Applicant: Semiconductor Energy Laboratory Co., Ltd., Atsugi-shi (JP)

(72) Inventor: Yuji IWAKI, Isehara (JP)

(21) Appl. No.: 14/324,819

(22) Filed: Jul. 7, 2014

(30) Foreign Application Priority Data
Jul. 12, 2013 (JP) 2013-146068

(51) Int. Cl. G06T 3/00

(52) U.S. Cl. CPC G06T 3/00
USPC 345/643

(57) ABSTRACT

A novel highly browsable data processing device is provided. A novel highly portable data processing device is provided. A novel highly browsable data processing system is provided. A novel highly portable data processing system is provided. The inventor has conceived a structure including an input/output device that includes a communication unit that receives a display instruction, a position-measuring unit that measures the position of a sign, and produces and supplies position data, and a display unit; and an arithmetic device that produces image data on the basis of the display instruction and the position data.

### BACKGROUND OF THE INVENTION

1. Field of the Invention

The present invention relates to an object, a method, or a manufacturing method. The present invention also relates to a process, a machine, manufacture, or a composition of matter. In particular, the present invention relates to, for example, a human interface, a semiconductor device, a display device, a light-emitting device, a power storage device, a system, a driving method thereof, or a manufacturing method thereof. In particular, the present invention relates to, for example, a method and a program for processing and displaying image information, and a device including a recording medium in which the program is recorded. In particular, the present invention relates to, for example, a method for processing and displaying image data by which an image including information processed by a data processing device provided with a display unit is displayed, a program for displaying an image including information processed by a data processing device provided with a display unit, a data processing device including a recording medium in which the program is recorded, and a data processing system.

2. Description of the Related Art

The social infrastructures relating to means for transmitting information have advanced. This has made it possible to acquire, process, and send out many pieces and various kinds of information with the use of a data processing device not only at home or office but also at other visiting places.

With this being the situation, portable data processing devices are under active development.

For example, portable data processing devices are often used outdoors, and force might be accidentally applied by dropping to the data processing devices and display devices included in them. As an example of a display device that is not easily broken, a display device having high adhesiveness between a structure body by which a light-emitting layer is divided and a second electrode layer is known (Patent Document 1).

### REFERENCE

### Patent Document 1: Japanese Published Patent Application No. 2012-190794

### SUMMARY OF THE INVENTION

An object of one embodiment of the present invention is to provide a highly browsable data processing device. Another object is to provide a highly portable data processing device.

Another object is to provide a highly browsable data processing system. Another object is to provide a highly portable data processing system.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a data processing device that includes an input/output device that receives image data and supplies a display instruction and position data; and an arithmetic device that receives the display instruction and the position data, produces image data on the basis of the display instruction and the position data, and supplies the image data. The input/output device includes a communication unit that receives the display instruction; a position-measuring unit that measures the position of a sign and produces the position data; and a display unit that displays the image data. The arithmetic device includes an arithmetic unit and a storage unit that stores a program to be executed by the arithmetic unit. In the program, the image data is produced on the basis of the display instruction and the position data.

The data processing device of one embodiment of the present invention includes the input/output device that includes the communication unit that receives the display instruction, the position-measuring unit that measures the position of the sign and produces the position data, and the display unit; and the arithmetic device that produces the image data on the basis of the display instruction and the position data. Accordingly, the image data can be produced on the basis of the display instruction and/or the positional relation between the data processing device and the sign and can be displayed. As a result, a highly browsable data processing device or a highly portable data processing device can be provided.

Another embodiment of the present invention is a data processing device that includes the program including: a first step of performing initialization; a second step of determining a first correction parameter on the basis of supplied position data; a third step of producing the image data on the basis of the first correction parameter; a fourth step of allowing interrupt processing; a fifth step of displaying the image data; a sixth step of proceeding to a seventh step when a termination instruction has been supplied in the interrupt processing and returning to the fifth step when the termination instruction has not been supplied in the interrupt processing; and the seventh step of terminating the program. The interrupt processing includes: an eighth step of proceeding to a ninth step when the display instruction has been supplied and proceeding to a tenth step when the display instruction has not been supplied; the ninth step of producing the image data on the basis of the display instruction; the tenth step of determining a second correction parameter on the basis of the position data; an eleventh step of proceeding to a twelfth step when the second correction parameter has changed from the first correction parameter and proceeding to a thirteenth step when the second correction parameter has not changed from the first correction parameter, the twelfth step of producing image data on the basis of the second correction parameter; and the thirteenth step of recovering from the interrupt processing.

The data processing device of one embodiment of the present invention includes the storage unit that stores the program including the step of producing the image data on the basis of the display instruction and/or the position data. Accordingly, the image data can be produced on the basis of the display instruction and/or a change in the positions of the data processing device and the sign and can be redisplayed. In addition, for example, a user of the data processing device can select part of an imaginary image that is larger than the display unit can display the part of the imaginary image on the display unit by changing the position of the data processing device or the sign. In other words, the user of the data processing device can intuitively select a region of the image that is to be displayed on the display unit by moving the data processing device or the sign. As a result, a highly browsable data processing device or a highly portable data processing device can be provided.

Another embodiment of the present invention is a data processing device in which the position-measuring unit includes a sensor that is placed along the display unit and supplies a sensing signal; and a sensing signal processing circuit that processes the sensing signal.

Another embodiment of the present invention is a data processing device in which the position-measuring unit includes an imaging sensor placed along the display unit and an image processing circuit. The image processing circuit executes a first step of performing initialization: a second step of capturing a sign image with the imaging sensor; a third step of binarizing the sign image to generate a binary image; a fourth step of proceeding to a fifth step when the binary image has a predetermined pattern and proceeding to a sixth step when the binary image does not have the predetermined pattern; the fifth step of identifying coordinates of the pattern of the binary image to produce position data of the sign; and the sixth step of returning to the first step.

The data processing device of one embodiment of the present invention includes the position-measuring unit including the sensor that is placed along the display unit and can sense the sign and supply a signal. Accordingly, the image data can be produced on the basis of the display instruction and/or a change in the positions of the display unit and the sign and can be redisplayed. In addition, the user of the data processing device can intuitively select a region of the image that is to be displayed on the display unit by moving the data processing device or the sign. As a result, a highly browsable data processing device or a highly portable data processing device can be provided.

Another embodiment of the present invention is a data processing system that includes a sign; a first data processing device that measures the position of the sign and supplies a display instruction and first position data; and a second data processing device that measures the position of the sign and receives the display instruction and the first position data. The first data processing device includes a first input/output device that supplies the display instruction and the first position data. The first input/output device includes a first position-measuring unit that measures the position of the sign and produces the first position data; a first input unit that can supply the display instruction; and a first communication unit that can supply the display instruction and the first position data. The second data processing device includes a second input/output device that receives the image data and supplies the display instruction, the first position data, and second position data; and an arithmetic device that receives the first position data and the second position data and produces and supplies image data on the basis of the display instruction, the first position data, and the second position data. The second input/output device includes a second communication unit that receives the display instruction and the first position data, a second position-measuring unit that measures the position of the sign and produces second position data, and a display unit that displays the image data. The arithmetic device includes an arithmetic unit and a storage unit that stores a program to be executed by the arithmetic unit. In the program, the image data is produced on the basis of the display instruction, the first position data, and the second position data.

The data processing system of one embodiment of the present invention includes the sign, the first data processing device, and the second data processing device. The first data processing device supplies the display instruction and the first position data of the sign, and the second data processing device obtains the second position data of the sign and receives the display instruction and the first position data. Accordingly, the second data processing device can produce the image data on the basis of the display instruction supplied by the first data processing device and/or the positional relation to the first data processing device and can redisplay the image data. As a result, a highly browsable data processing system or a highly portable data processing system can be provided.

Another embodiment of the present invention is a data processing system that includes the program including: a first step of performing initialization; a second step of determining a first correction parameter on the basis of the first position data and the second position data; a third step of producing the image data on the basis of the first correction parameter; a fourth step of allowing interrupt processing; a fifth step of displaying the image data; a sixth step of proceeding to a seventh step when a termination instruction has been supplied in the interrupt processing and returning to the fifth step when the termination instruction has not been supplied; and the seventh step of terminating the program. The interrupt processing includes: an eighth step of proceeding to a ninth step when the display instruction has been supplied and proceeding to a tenth step when the display instruction has not been supplied; the ninth step of producing the image data on the basis of the display instruction; the tenth step of determining a second correction parameter on the basis of the first position data and the second position data; an eleventh step of proceeding to a twelfth step when the second correction parameter has changed from the first correction parameter and proceeding to a thirteenth step when the second correction parameter has not changed from the first correction parameter; the twelfth step of producing image data on the basis of the second correction parameter; and the thirteenth step of recovering from the interrupt processing.

The data processing system of one embodiment of the present invention includes the sign, the first data processing device, and the second data processing device. The second data processing device includes the storage unit that stores the program including the step of producing the image data on the basis of the display instruction, the first position data, and the second position data. Accordingly, the second data processing device can produce image data on the basis of the display instruction and the first position data and can redisplay the image data. In addition, the user of the data processing system can intuitively select a region of the image that is to be displayed on the display unit of the second data processing device by moving the first data processing device or the second data processing device. As a result, a highly browsable data processing system or a highly portable data processing system can be provided.

Another embodiment of the present invention is a data processing system in which the first data processing device includes the sign.

The data processing system of one embodiment of the present invention includes the first data processing device and the second data processing device. The first data processing device is provided with the sign and can supply the display instruction. The second data processing device measures the position of the sign and receives the display instruction. Accordingly, the second data processing device can produce image data on the basis of the display instruction supplied by the first data processing device and/or the positional relation to the first data processing device and can redisplay the image data. As a result, a highly browsable data processing system or a highly portable data processing system can be provided.

According to one embodiment of the present invention, a highly browsable data processing device can be provided or a highly portable data processing device can be provided.

According to one embodiment of the present invention, a highly browsable data processing system can be provided or a highly portable data processing system can be provided.

### BRIEF DESCRIPTION OF THE DRAWINGS

FIG. 1 is a block diagram illustrating a data processing device of one embodiment.

FIGS. 2A and 2B are flow charts showing a program stored in a data processing device of one embodiment.

FIGS. 3A and 3B are schematic diagrams illustrating operations in which a data processing device of one embodiment displays image data.

FIGS. 4A to 4C illustrate a method in which a data processing device of one embodiment measures the position of a sign.

FIG. 5 is a block diagram illustrating a data processing system of one embodiment.

FIGS. 6A and 6B are flow charts showing a program stored in a data processing device of one embodiment.

FIG. 7 is a schematic diagram illustrating a data processing system of one embodiment including a sign and data processing devices.

FIGS. 8A and 8B are schematic diagrams each illustrating a data processing system of one embodiment including a data processing device provided together with a sign.

FIGS. 9A1, 9A2, and 9B each illustrate a structure of a data processing device of one embodiment provided together with a sign.

FIGS. 10A and 10B are schematic diagrams each illustrating an operation of a data processing system of one embodiment including data processing device provided together with a sign.

FIGS. 11A to 11C are schematic diagrams illustrating operations of a data processing system of one embodiment including data processing devices provided together with a sign.

FIGS. 12A to 12C illustrate a structure of an input/output device that can be used for a data processing device of one embodiment.

FIGS. 13A and 13B illustrate a structure of an input/output device that can be used for a data processing device of one embodiment.

FIG. 14 illustrates a structure of an input/output device that can be used for a data processing device of one embodiment.

### DETAILED DESCRIPTION OF THE INVENTION

Embodiments will be described in detail with reference to the accompanying drawings. Note that the present invention is not limited to the description below, and it is easily understood by those skilled in the art that various changes and modifications can be made without departing from the purpose and scope of the present invention. Therefore, the invention should not be construed as being limited to the description in the following embodiments. Note that in the structures of the invention described below, the same portions or portions having similar functions are denoted by the same reference numerals in different drawings, and description of such portions is not repeated.

### Embodiment 1

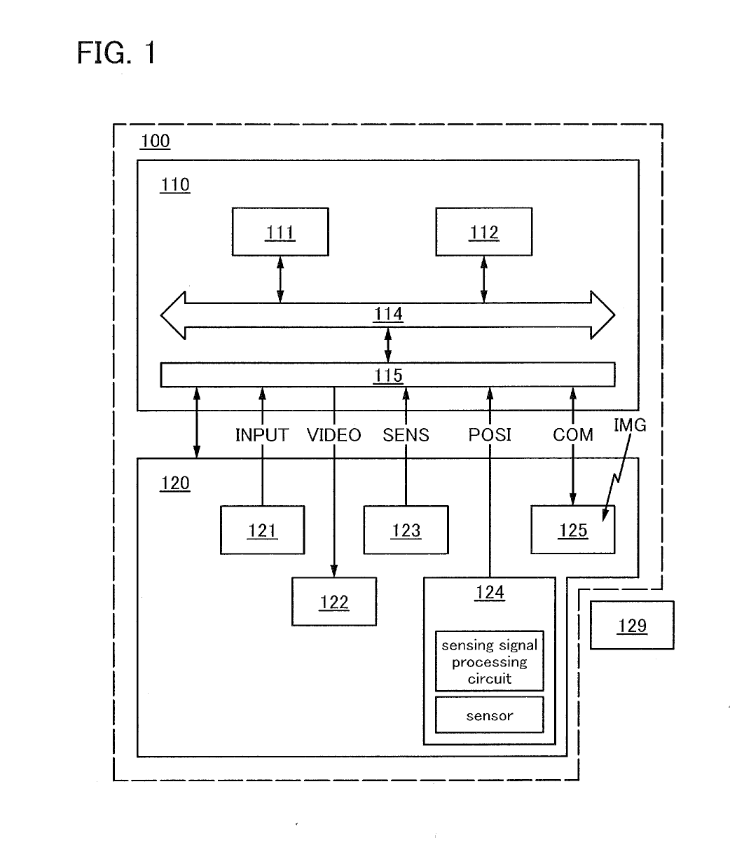

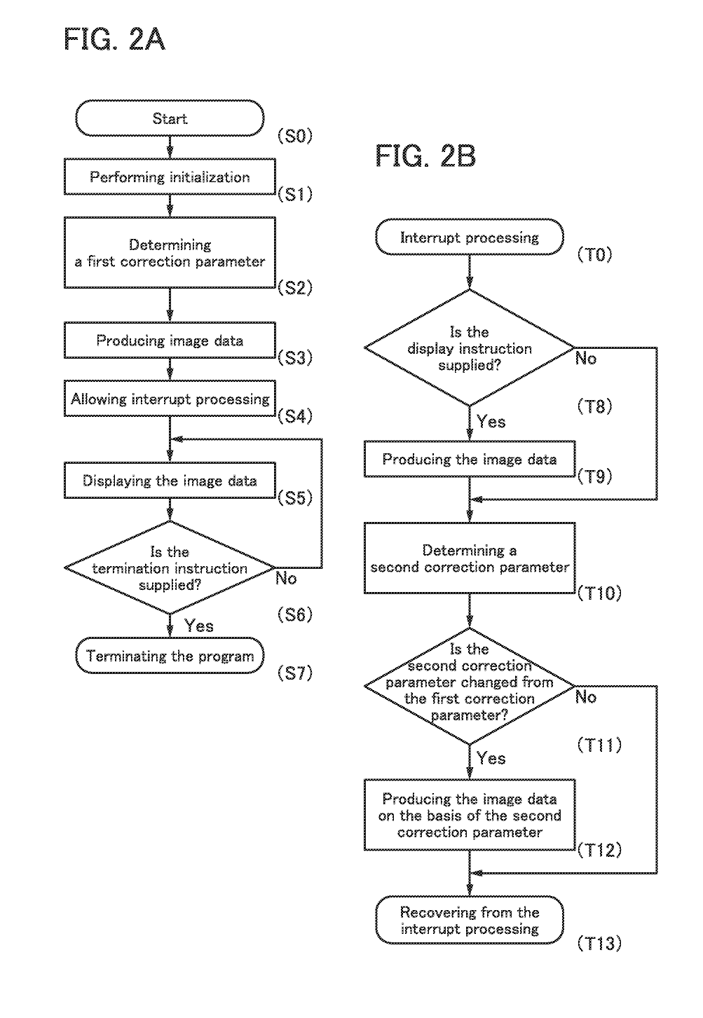

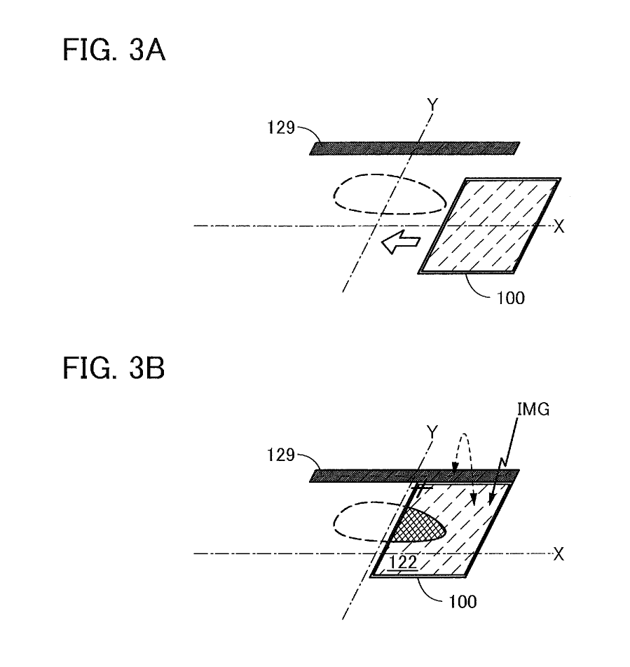

In this embodiment, a structure of a data processing device 100 of one embodiment of the present invention is described with reference to FIG. 1. FIGS. 2A and 2B, and FIGS. 3A and 3B.

FIG. 1 is a block diagram illustrating the structure of the data processing device 100 described as an example in this embodiment.

FIGS. 2A and 2B are flow charts showing operations executed by a program stored in the data processing device 100 described as an example in this embodiment. FIG. 2A is a flow chart showing main processing. FIG. 2B is a flow chart showing interrupt processing.

FIGS. 3A and 3B are schematic diagrams illustrating operations of the data processing device 100 described as an example in this embodiment.

The data processing device 100 described in this embodiment includes an input/output device 120 that receives image data VIDEO and supplies a display instruction IMG and position data POSI; and an arithmetic device 110 that receives the display instruction IMG and the position data POSI, produces the image data VIDEO on the basis of the display instruction IMG and the position data POSI, and supplies the image data VIDEO.

The input/output device 120 includes a communication unit 125 that receives the display instruction IMG; a position-measuring unit 124 that measures the position of a sign 129 and produces the position data POSI; and a display unit 122 that displays the image data VIDEO.

The arithmetic device 110 includes an arithmetic unit 111 and a storage unit 112 that stores a program to be executed by the arithmetic unit 11. In the program, the image data VIDEO is produced on the basis of the display instruction IMG and the position data POSI.

The data processing device 100 described as an example in this embodiment includes the input/output device 120 including the communication unit 125 that receives the display instruction IMG, the position-measuring unit 124 that measures the position of the sign 129 and produces and supplies the position data POSI, and the display unit 122; and the arithmetic device 110 that produces the image data VIDEO on the basis of the display instruction IMG and the position data POSI. Accordingly, the image data VIDEO can be produced on the basis of the display instruction IMG and/or the positional relation between the data processing device 100 and the sign 129 and can be displayed. As a result, a highly browsable data processing device or a highly portable data processing device can be provided.

The arithmetic device 110 described as an example in this embodiment includes an input/output interface 115 and a transmission path 114 (see FIG. 1).

The input/output interface 115 can receive data supplied by the input/output device 120 and supply data to the input/output device 120.

The transmission path 114 can supply data to the arithmetic unit 111, the storage unit 112, and the input/output interface 115. In addition, the arithmetic unit 111, the storage unit 112, and the input/output interface 115 can supply data to the transmission path 114.

The input/output device 120 includes an input unit 121, a sensing unit 123, and the like.

The input unit 121 can supply an operation instruction INPUT or the like. Note that the operation instruction INPUT includes a termination instruction or the like. The termination instruction is an instruction to terminate the program.

The sensing unit 123 includes a sensor and can supply a sensing signal SENS corresponding to data sensed by the sensor.

The position of the sign 129 is measured by the position-measuring unit 124; thus, the position-measuring unit 124 can identify the position of the sign 129.

Note that these portions cannot be clearly distinguished and one portion also serves as another portion or include part of another portion in some cases. For example, a touch panel in which a display unit is overlapped with a touch sensor serves as the input unit 121 as well as the display unit 122.

The data processing device 100 described as an example in this embodiment includes the storage unit 112 that stores the program including the following steps (see FIGS. 2A and 2B and FIGS. 3A and 3B).

### <<Program>>

In a first step, initialization is performed (see (S1) in FIG. 2A).

A state in the first step as well as the sign 129 and an X axis and a Y axis that are determined on the basis of the sign 129 are illustrated in FIG. 3A.

In a second step, a first correction parameter is determined on the basis of the position data POSI supplied by the position-measuring unit 124 (see (S2) in FIG. 2A).

A state in the second step is illustrated in FIG. 3B. The data processing device 100 can measure the position of the sign 129. In other words, the data processing device 100 can specify the positional relation to the sign 129. For example, the data processing device 100 can specify its position on a plane defined by the X axis and the Y axis in the drawing.

An example of a method for determining the first correction parameter is described. An origin used when the data processing device 100 displays image data on the display unit 122 is represented by a cross in the upper-left part of the display unit 122 (see FIG. 3B). The inverse of a vector from an intersection between the X axis and the Y axis that are determined on the basis of the sign 129 to the origin used when the data processing device 100 displays image data can be used as the first correction parameter.

In a third step, image data VIDEO is produced on the basis of the first correction parameter (see (S3) in FIG. 2A).

The image data VIDEO can be produced by, for example, adding the first correction parameter to oval image data based on the intersection between the X axis and the Y axis (see FIG. 3B). Part of the produced oval image is displayed in the data processing device 100.

In a fourth step, interrupt processing is allowed (see (S4) in FIG. 2A).

In a fifth step, the image data VIDEO is displayed (see (S5) in FIG. 2A).

In a sixth step, the operation proceeds to a seventh step when a termination instruction has been supplied in the interrupt processing and returns to the fifth step when the termination instruction has not been supplied in the interrupt processing (see (S6) in FIG. 2A).

In the seventh step, the program is terminated (see (S7) in FIG. 2A).

The interrupt processing is described (see FIG. 2B).

In an eighth step, the operation proceeds to a ninth step when the display instruction IMG has been supplied and proceeds to a tenth step when the display instruction IMG has not been supplied (see (T8) in FIG. 2B).

In the ninth step, the image data VIDEO is produced on the basis of the display instruction IMG (see (T9) in FIG. 2B).

For example, in the case where a display instruction IMG to move an image to the right has been supplied, image data VIDEO on the image moved to the right is produced.

In the tenth step, a second correction parameter is determined from the position data POSI (see (T10) in FIG. 2B).

The second correction parameter can be determined by the same method as the first correction parameter.

For example, in the case where the data processing device 100 is moved, the inverse of a vector from the intersection between the X axis and the Y axis that are determined on the basis of the sign 129 to an origin used when the data processing device 100 after the move displays the image data can be used as the second correction parameter.

In an eleventh step, the operation proceeds to a twelfth step when the second correction parameter is different from the first correction parameter and proceeds to a thirteenth step when the second correction parameter is the same as the first correction parameter (see (T11) in FIG. 2B).

In the twelfth step, image data VIDEO is produced on the basis of the second correction parameter (see (T12) in FIG. 2B).

In the thirteenth step, the operation recovers from the interrupt processing (see (T13) in FIG. 2B).

The data processing device 100 described as an example in this embodiment includes the storage unit 112 that stores the program including the step of producing the image data VIDEO on the basis of the display instruction IMG and/or the position data POSI. Accordingly, the image data VIDEO can be produced on the basis of the display instruction IMG and/or a change in the positions of the data processing device 100 and the sign 129 and can be redisplayed. In addition, the user of the data processing device 100 can intuitively select a region of the image that is to be displayed on the display unit 122 by moving the data processing device 100 or the sign 129. As a result, a highly browsable data processing device or a highly portable data processing device can be provided.

Individual components included in the data processing device 100 of one embodiment of the present invention are described below.

### <<Input/Output Device>>

The input/output device 120 is connected to the transmission path 114 via the input/output interface 115. The input/output device 120 can supply external information to the data processing device 100. The input/output device 120 can also supply information to the outside from the inside of the data processing device 100.

### <<Communication Unit>>

The communication unit 125 connects the data processing device 100 to an external device or network. The data processing device 100 can obtain or supply data COM including a variety of instructions from or to the outside.

An example of the data COM is the display instruction IMG. The display instruction IMG is, for example, an instruction to make the arithmetic unit 111 produce or delete image data VIDEO. The display instruction IMG includes an instruction to specify the position where the image data VIDEO is to be displayed and an instruction to select the image data VIDEO.

Examples of the communication unit 125 include a unit that communicates with another device close thereto without wires using radio waves, infrared rays, or the like, and a unit that communicates with another device with wire. In addition, a communication device connected to network with wire or without wires using radio waves or the like can be given; specific examples thereof are a hub, a router, and a modem.

### <<Sign and Position-Measuring Unit>>

As the sign 129, for example, electromagnetic waves such as radio waves, light, or magnetic force, sound waves, an image, a pattern, or the shape or position of an object such as a protrusion can be used.

The position-measuring unit 124 includes a sensor that senses the sign 129 and supplies a sensing signal and a sensing signal processing circuit that processes a sensing signal and produces and supplies position data.

A sensor and a sensing signal processing circuit that can measure the position of the sign 129 are selected and used. Specifically, in the case where a pattern of an object near the data processing device or a scenic image is used as the sign 129, an imaging sensor can be used as the position-measuring unit 124 and an image processing circuit can be used as the sensing signal processing circuit. Alternatively, in the case where the sign 129 is provided with a plurality of transmitters that emit signals such as electromagnetic waves modulated by different methods, a receiver can be used as the position-measuring unit 124. Alternatively, a satellite of a satellite navigation system, for example, a satellite that emits global positioning system (GPS) signals can be used as the sign 129.

Note that structures of the sign and the position-measuring unit are specifically described in Embodiment 2.

### <<Display Unit>>

The display unit 122 displays the image data VIDEO. Note that continuous image data is displayed on the display unit 122 and a display unit of another data processing device placed next to the display unit 122, whereby the two display units can be used as one large screen. A region surrounding a portion of the display unit 122 where the image data VIDEO is displayed (the region is also referred to as a bezel) is preferably as small as possible, in which case a space between the two display units can be small. Thus, highly browsable display is possible.

Note that when the display unit 122 is flexible, it can be folded. Structures of a flexible display unit that can be applied to this embodiment are specifically described in Embodiment 5 and 6.

The display unit 122 may be foldable in two parts or three or more parts. As the foldable number gets larger, a highly portable data processing device can be provided.

### <<Input Unit 121>>

The input unit 121 can supply an operation instruction INPUT including a termination instruction or the like. Note that the termination instruction is an instruction to terminate the program.

As the input unit 121, any of various human interfaces and the like can be used. Specifically, a keyboard, a mouse, a touch sensor, a microphone, a camera, or the like can be used. In particular, supplying an operation instruction using a pointer is convenient because it enables intuitional operation.

For example, in the case where a touch panel is used as the input unit 121 that is overlapped with and integrally formed with the display unit 122, a user of the data processing device 100 can input the operation instruction INPUT including the termination instruction, and the like by gestures (e.g., tap, drag, swipe, and pinch-in) using fingers as a pointer on the touch panel.

### <<Sensing Unit>>

The sensing unit 123 senses the states of the data processing device 100 and the circumstances and supplies sensing data SENS.

The sensing unit 123 senses acceleration, a direction, pressure, temperature, humidity, and the like and may supply data thereon.

### <<Other Structures>>

As the input/output device 120, for example, a camera, a microphone, a read-only external memory, an external memory, a communication device, a scanner, a speaker, a printer, or the like can be used.

Specifically, examples of a camera include a digital camera and a digital video camera.

Examples of an external memory include a hard disk and a removable memory. Examples of a read-only external memory include a CD-ROM and a DVD-ROM.

This embodiment can be combined as appropriate with any of the other embodiments in this specification.

### Embodiment 2

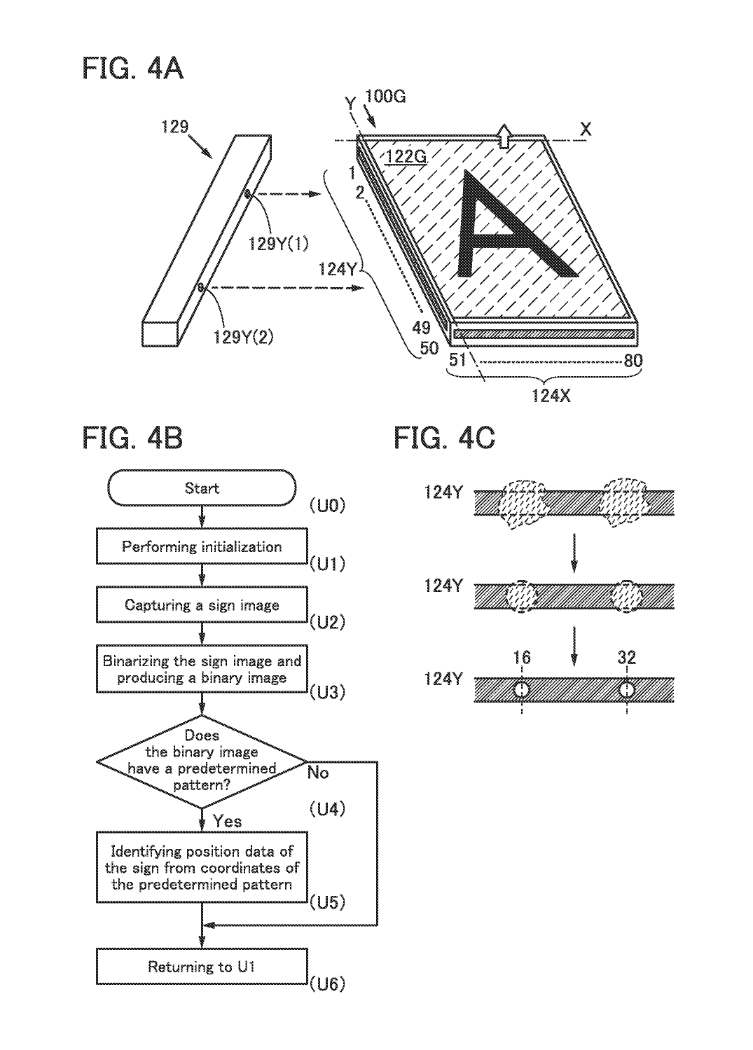

In this embodiment, a structure of a data processing device 100G of one embodiment of the present invention is described with reference to FIGS. 4A to 4C.

FIGS. 4A to 4C are schematic diagrams of the sign 129 and the data processing device 100G that measures the position of the sign 129 and a flow chart. FIG. 4A is a schematic diagram illustrating the sign 129 and the data processing device 100G placed adjacent thereto. FIG. 4B is a flow chart showing how the position-measuring unit 124 of the data processing device 100G measures the position of the sign 129. FIG. 4C is a diagram illustrating a method for measuring the position of the sign 129 from an obtained image.

The position-measuring unit 124 of the data processing device 100G described in this embodiment includes a sensor 124Y and a sensor 124X that are placed along a display unit 122G and supply sensing signals; and a sensing signal processing circuit that processes the sensing signals (see FIG. 4A).

The sensor 124Y is placed along one side (e.g., long side) of the display unit 122G, and the sensor 124X is placed along another side (e.g. short side) of the display unit 122G. Note that a sensor that can sense the sign 129 and measure the position of the sign 129 is selected and used as the sensor 124Y and the sensor 124X.

For example, a linear sensor in which sensors are arranged in a line can be used as the sensor 124Y and the sensor 124X.

The sensor 124Y and the sensor 124X are placed around the display unit 122G, so that the position of the sign 129 can be measured near the display unit 122G and the accuracy of position measurement can be increased.

Note that the sensing signal processing circuit processes sensing signals that the sensor 124Y and the sensor 124X supply upon sensing the sign 129 and measures the position of the sign 129.

A position-measuring unit that includes an imaging sensor and an image processing circuit is described.

Note that the sign 129 is provided with a light-emitting element 129Y(1) and a light-emitting element 129Y(2) arranged at a predetermined interval. This enables the position-measuring unit 124 to identify the sign 129. For example, the position of the sign 129 can be measured only when the position-measuring unit 124 senses the light-emitting element 129Y(1) and the light-emitting element 129Y(2) arranged at a predetermined interval.

In the data processing device 100G described as an example in this embodiment, the position-measuring unit 124 includes the imaging sensor (the sensor 124Y and the sensor 124X) placed around the display unit 122G and the image processing circuit (the sensing signal processing circuit).

In the sensor 124Y, 50 imaging sensors are arranged in a line. In the sensor 124X, 30 imaging sensors are arranged in a line. The sensor 124Y and the sensor 124X can supply a captured image to the image processing circuit not illustrated.

The image processing circuit executes processing including the following steps.

In a first step, initialization is performed (see (U1) in FIG. 4B).

In a second step, an image of the sign 129 (hereinafter, referred to as a sign image) is captured by the imaging sensors (the sensor 124Y and the sensor 124X) (see (U2) in FIG. 4B).

In a third step, the sign image is binarized to generate a binary image (see (U3) in FIG. 4B).

In a fourth step, the operation proceeds to a fifth step when the binary image has a predetermined pattern and proceeds to a sixth step when the binary image does not have the predetermined pattern (see (U4) in FIG. 4B).

In the fifth step, position data of the sign 129 is produced from coordinates of the predetermined pattern of the binary image (see (U5) in FIG. 4B).

In the sixth step, the operation returns to the first step (see (U6) in FIG. 4B).

The data processing device described as an example in this embodiment includes the position-measuring unit including the sensors 124Y and 124X that are placed along the display unit 122G and can sense the sign 129 and supply signals. Accordingly, the image data can be produced on the basis of a display instruction and/or a change in the positions of the display unit and the sign and can be redisplayed. In addition, the user of the data processing device can intuitively select a region of the image that is to be displayed on the display unit by moving the data processing device or the sign. As a result, a highly browsable data processing device or a highly portable data processing device can be provided.

A method in which the image processing circuit of the data processing device 100G described as an example in this embodiment measures the position of the sign 129 from an image captured using the sensor 124Y is described with reference to FIG. 4C.

FIG. 4C schematically illustrate images of the light-emitting elements captured by the imaging sensor (the sensor 124Y) in descending order of distance between the light-emitting elements and the imaging sensor (the sensor 124Y).

In the case where the imaging sensor (the sensor 124Y) is away from the light-emitting elements 129Y(1) and 129Y(2), the images of the light-emitting elements captured by the imaging sensor (the sensor 124Y) are dark and the images of peripheries of the light-emitting elements are blurred.

As the distance between the light-emitting elements 129Y(1) and 129Y(2) and the imaging sensor (the sensor 124Y) decreases, the images of the light-emitting elements captured by the imaging sensor (the sensor 124Y) gradually become brighter and the images of the peripheries of the light-emitting elements gradually become clearer.

Furthermore, when the imaging sensor (the sensor 124Y) is in contact with the light-emitting elements 129Y(1) and 129Y(2), the images of the light-emitting elements are very bright and clear. Note that clear images captured by the sixteenth imaging sensor and the thirty-second imaging sensor are shown in FIG. 4C.

The image processing circuit can binarize an image captured by the imaging sensor (the sensor 124Y). In addition, it is possible to find whether or not the image is brighter than predetermined brightness, whether or not a contour of the image has a predetermined size, or by which sensor of the linear sensor the sign is sensed. Thus, it is possible to measure the position of the sensor with which the target sign is in contact in the sensor 124Y. Furthermore, it is possible to find whether or not patterns arranged at a predetermined interval are included; thus, it is also possible to find whether the sign is a target sign.

This embodiment can be combined as appropriate with any of the other embodiments in this specification.

### Embodiment 3

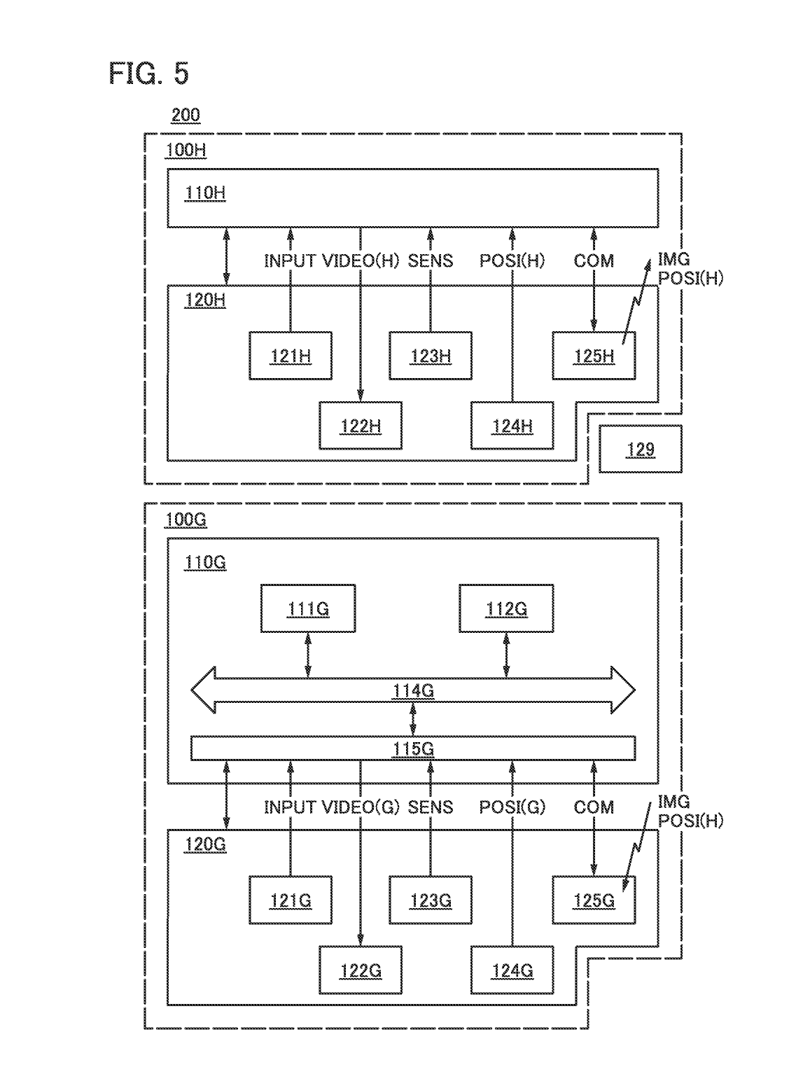

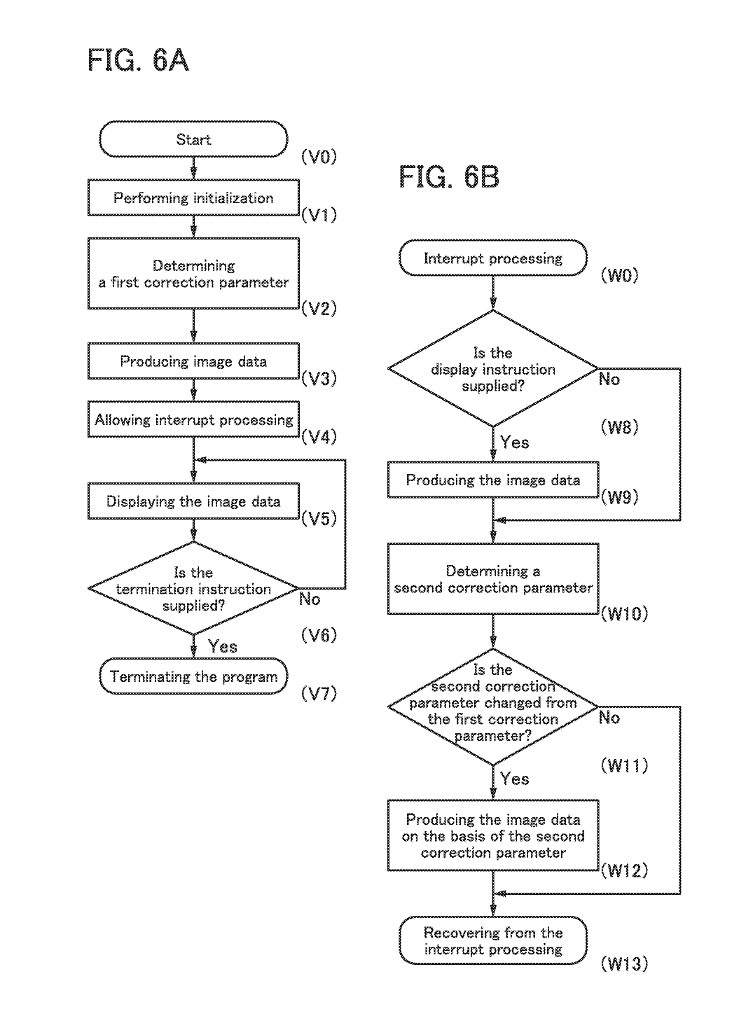

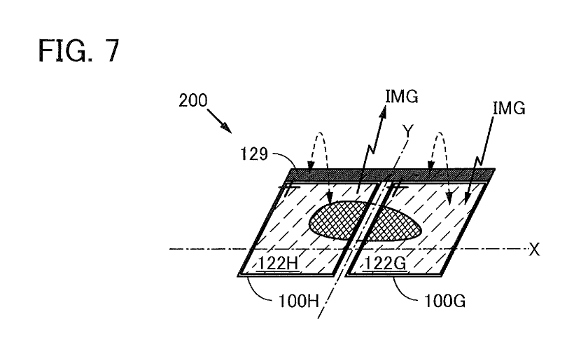

In this embodiment, a data processing system 200 of one embodiment of the present invention is described with reference to FIG. 5, FIGS. 6A and 6B, and FIG. 7.

FIG. 5 is a block diagram illustrating a structure of the data processing system 200 described as an example in this embodiment.

FIGS. 6A and 6B are flow charts showing a program stored in one data processing device 100G included in the data processing system 200. FIG. 6A is a flow chart showing main processing. FIG. 6B is a flow chart showing interrupt processing.

FIG. 7 schematically illustrates an operation in which the data processing system 200 displays image data.

The data processing system 200 described as an example in this embodiment includes the sign 129, a first data processing device 100H, and a second data processing device 100G (see FIG. 5). The first data processing device 100H measures the position of the sign 129 and supplies a display instruction IMG and first position data POSI(H). The second data processing device 100G measures the position of the sign 129 and receives the display instruction IMG and the first position data POSI(H).

The first data processing device 100H includes a first input/output device 120H that supplies the display instruction IMG and the first position data POSI(H). The first input/output device 120H includes a first position-measuring unit 124H that measures the position of the sign 129 and produces the first position data POSI(H); a first input unit 121H that can supply the display instruction IMG; and a first communication unit 125H that can supply the display instruction IMG and the first position data POSI(H).

The second data processing device 100G includes a second input/output device 120G and an arithmetic device 110G. The second input/output device 120G receives image data VIDEO(G) and supplies the display instruction IMG, the first position data POSI(H), and second position data POSI(G). The arithmetic device 110G receives the first position data POSI(H) and the second position data POSI(G), produces the image data VIDEO(G) on the basis of the display instruction IMG, the first position data POSI(H), and the second position data POSI(G); and supplies the image data VIDEO(G).

The second input/output device 120G includes a second communication unit 125G that receives the display instruction IMG and the first position data POSI(H); a second position-measuring unit 124G that measures the position of the sign 129 and produces the second position data POSI(G); and the display unit 122G that displays the image data VIDEO(G).

The arithmetic device 110G includes an arithmetic unit 111G and a storage unit 112G that stores a program to be executed by the arithmetic unit 111G.

In the program, the image data VIDEO(G) is produced on the basis of the display instruction IMG, the first position data POSI(H), and the second position data POSI(G).

The data processing system 200 described as an example in this embodiment includes the sign 129, the first data processing device 100H, and the second data processing device 100G. The first data processing device 100H supplies the display instruction IMG and the first position data POSI(H) on the sign 129. The second data processing device 100G obtains the second position data POSI(G) on the sign 129 and receives the display instruction IMG and the first position data POSI(H). Accordingly, the second data processing device 100G can produce the image data VIDEO on the basis of the display instruction IMG supplied by the first data processing device 100H and/or the positional relation to the first data processing device 100H and can redisplay the image data VIDEO. As a result, a highly browsable data processing system or a highly portable data processing system can be provided.

The arithmetic device 110G described as an example in this embodiment includes an input/output interface 115G and a transmission path 114G (see FIG. 5).

The second input/output interface 115G can receive data from the second input/output device 120G and supply data to the input/output device 120G.

The transmission path 114G can supply data to the arithmetic unit 111G, the storage unit 112G, and the input/output interface 115G. In addition, the arithmetic unit 111G, the storage unit 112G, and the input/output interface 115G can supply data to the transmission path 114G.

The first input/output device 120H includes the first input unit 121H, a display unit 122H, and a sensing unit 123H, and the like. The second input/output device 120G includes a second input unit 121G, the display unit 122G, a sensing unit 123G, and the like.

The first input unit 121H can supply an operation instruction INPUT or the like. The second input unit 121G can supply the operation instruction INPUT or the like. Note that the operation instruction INPUT includes a display instruction IMG, a termination instruction, or the like. The termination instruction is an instruction to terminate the program.

The sensing units 123H and 123G include sensors and can supply sensing signals SENS corresponding to data sensed by the sensors.

The sign 129 is sensed by the position-measuring units 124H and 124G, whereby the position of the sign 129 can be found.

Note that these units cannot be clearly distinguished and one unit also serves as another unit or include part of another unit in some cases. For example, a touch panel in which a display unit is overlapped with a touch sensor serves as the input unit as well as the display unit.

The second data processing device 100G described as an example in this embodiment includes the storage unit 112G that stores the program including steps described below (see FIGS. 6A and 6B and FIG. 7).

### <<Program>>

In a first step, initialization is performed (see (V1) in FIG. 6A).

In a second step, a first correction parameter is determined on the basis of the first position data POSI(H) and the second position data POSI(G) (see (V2) in FIG. 6A).

A state in the second step is illustrated in FIG. 7. Both the first data processing device 100H and the second data processing device 1000 can measure the position of the sign 129. In other words, both the first data processing device 100H and the second data processing device 100G can specify the positional relation to the sign 129. For example, the first data processing device 100H and the second data processing device 100G can specify their positions on a plane defined by the X axis and the Y axis in the drawing.

An example of a method for determining the first correction parameter is described. An origin used when the first data processing device 100H displays image data on the display unit 122H is represented by a cross in the upper-left part of the display unit 122H; and in a similar manner, an origin used when the second data processing device 100G displays image data on the display unit 122G is represented by a cross in the upper-left part of the display unit 122G (see FIG. 7).

A vector H from an intersection between the X axis and the Y axis that are determined on the basis of the sign 129 to the origin used when the first data processing device 100H displays the image data can be used as the first position data POSI(H).

A vector G from the intersection between the X axis and the Y axis determined on the basis of the sign 129 to the origin used when the first data processing device 100G displays the image data can be used as the first position data POSI(G).

A vector obtained by subtracting the vector G from the vector H can be used as the first correction parameter.

In a third step, the image data VIDEO(G) is produced on the basis of the first correction parameter (see (V3) in FIG. 6A).

In a fourth step, an interrupt processing is allowed (see (V4) in FIG. 6A).

In a fifth step, the image data VIDEO(G) is displayed (see (V5) in FIG. 6A).

In a sixth step, the operation proceeds to a seventh step when a termination instruction has been supplied in the interrupt processing and returns to the fifth step when the termination instruction has not been supplied in the interrupt processing (see (V6) in FIG. 6A).

In a seventh fifth step, the program is terminated (see (V7) in FIG. 6A).

The interrupt processing is described (see FIG. 6B).

In an eighth step, the operation proceeds to a ninth step when a display instruction IMG has been supplied and proceeds to a tenth step when the display instruction IMG has not been supplied (see (W8) in FIG. 6B).

In the ninth step, the image data VIDEO(G) is produced on the basis of the display instruction IMG (see (W9) in FIG. 6B).

For example, in the case where the display instruction IMG to move an image to the right has been supplied, image data VIDEO(G) on the image moved to the right is produced.

In the tenth step, a second correction parameter is determined from the first position data POSI(H) and the second position data POSI(G) (see (W10) in FIG. 6B).

The second correction parameter can be determined by the same method as the first correction parameter.

For example, in the case where the first data processing device 100H is moved and the second data processing device 100G is not moved, the vector H (also referred to as the first position data POSI(H)) from the intersection between the X axis and the Y axis that are determined on the basis of the sign 129 to the origin used when the first data processing device 100H displays the image data changes; in contrast, the vector G (also referred to as the second position data POSI(G)) from the intersection to the origin used when the second data processing device 100G displays the image data does not change (see FIG. 7).

A vector obtained by subtracting the vector G from the vector H can be used as the second correction parameter.

In an eleventh step, the operation proceeds to a twelfth step when the second correction parameter is different from the first correction parameter and proceeds to a thirteenth step when the second correction parameter is the same as the first correction parameter (see (W11) in FIG. 6B).

In the twelfth step, the image data VIDEO(G) is produced on the basis of the second correction parameter (see (W12) in FIG. 6B).

In the thirteenth step, the operation recovers from the interrupt processing (see (W13) in FIG. 6B).

The data processing system 200 described as an example in this embodiment includes the sign 129, the first data processing device 100H, and the second data processing device 100G. The second data processing device 100G includes the storage unit that stores the program including the step of producing the image data VIDEO(G) on the basis of the display instruction IMG, the first position data POSI(H), and the second position data POSI(G). Accordingly, the second data processing device 100G can produce the image data VIDEO(G) on the basis of the display instruction IMG, the first position data POSI(H), and the second position data POSI(G) and can redisplay the image data. In addition, the user of the data processing system 200 can intuitively select a region of the image that is to be displayed on the display unit 122G of the second data processing device 100G by moving the first data processing device 100H or the second data processing device 100G. As a result, a highly browsable data processing system or a highly portable data processing system can be provided.

This embodiment can be combined as appropriate with any of the other embodiments in this specification.

### Embodiment 4

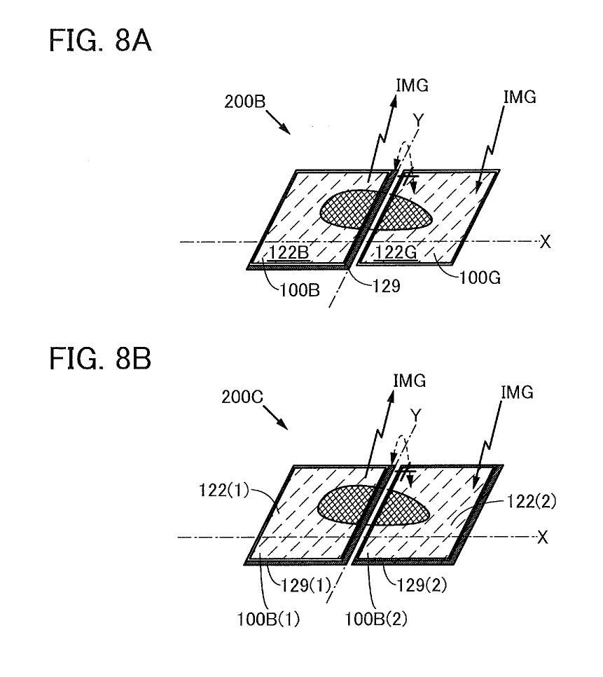

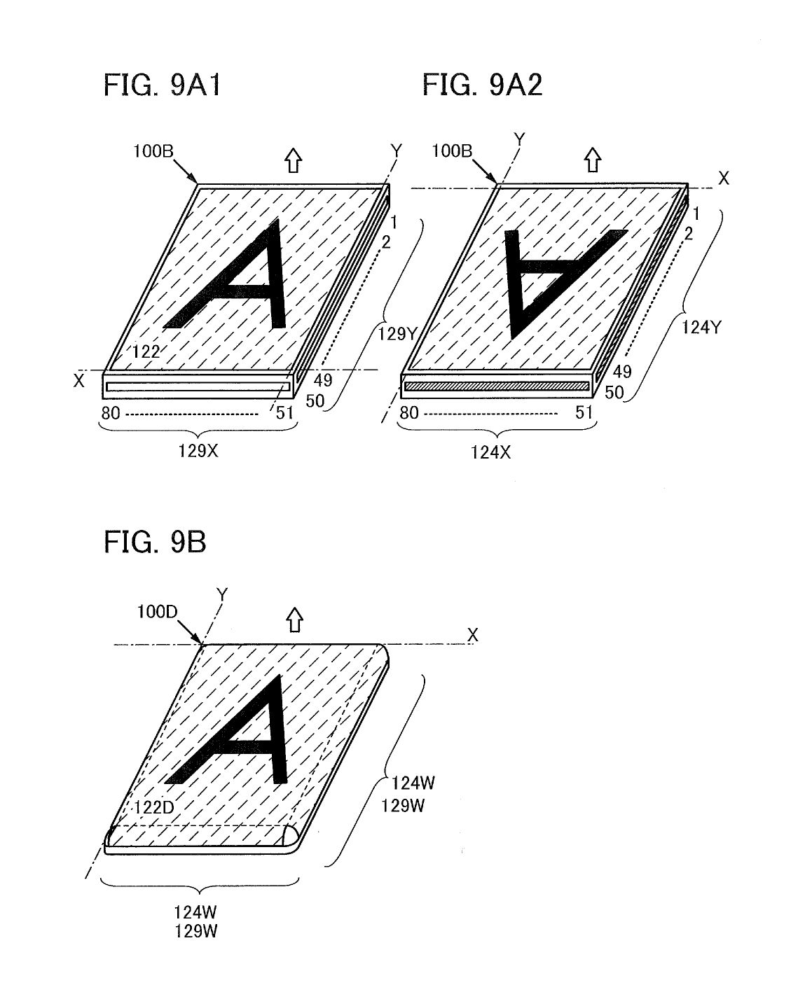

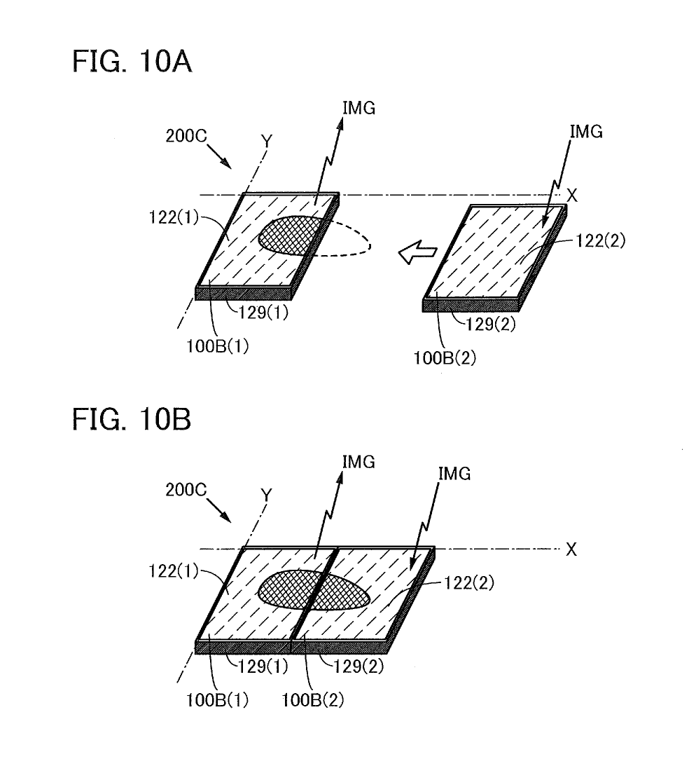

In this embodiment, a data processing system 200B of one embodiment of the present invention is described with reference to FIGS. 8A and 8B, FIGS. 9A1, 9A2, and 9B, and FIGS. 10A and 10B.

FIG. 8A is a schematic diagram illustrating a first data processing device 100B provided together with the sign 129 and the data processing system 200B including the first data processing device 100B.

FIG. 8B is a schematic diagram illustrating a data processing system 200C including a data processing device 100B(1) provided with a sign 129(1) and a data processing device 100B(2) provided with a sign 129(2).

FIGS. 9A1 and 9A2 are schematic diagrams each illustrating a structure of the first data processing device 100B provided with the sign 129. FIG. 9B is a schematic diagram illustrating a structure of a first data processing device 100D provided with the sign 129.

FIGS. 10A and 10B are schematic diagrams each illustrating the data processing system 200C displaying image data VIDEO.

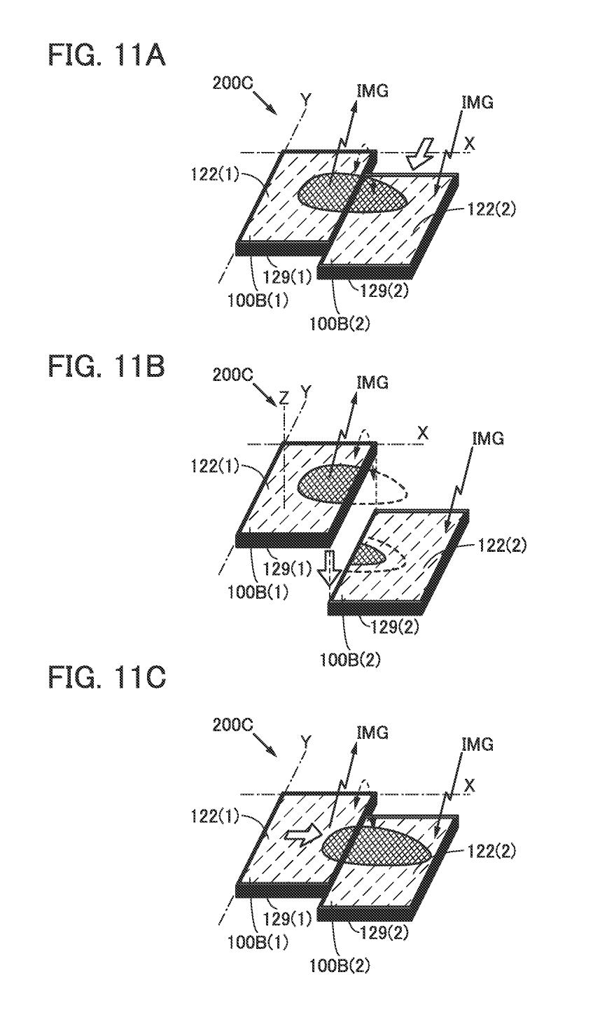

FIGS. 11A to 11C are schematic diagrams each illustrating the data processing system 200C displaying image data VIDEO.

The structure of the data processing system 200B is the same as the structure of the data processing system 200 described in Embodiment 3 except that the first data processing device 100B provided with the sign 129 is included.

In the data processing system 200B described as an example in this embodiment, the first data processing device 100B is provided with the sign 129 (see FIG. 8A).

The data processing system 200B described as an example in this embodiment includes the first data processing device 100B and the second data processing device 100G. The first data processing device 100B is provided with the sign 129 and can supply a display instruction IMG, and the second data processing device 100G measures the position of the sign 129 and receives the display instruction IMG. Accordingly, the second data processing device 100G can produce image data VIDEO on the basis of the display instruction supplied by the first data processing device 100B and/or the positional relation to the first data processing device 100B and can redisplay the image data VIDEO. As a result, a highly browsable data processing system or a highly portable data processing system can be provided.

In the data processing system 200C described as a modification example in this embodiment, the data processing device 100B(1) is provided with the sign 129(1), and the data processing device 100B(2) is provided with the sign 129(2) (see FIG. 8B).

The data processing system 200C described as an example in this embodiment includes the data processing device 100B(1) and the data processing device 100B(2). The data processing device 100B(1) is provided with the sign 129(1) and can supply a display instruction IMG, and the data processing device 100B(2) measures the position of the sign 129(1) and receives the display instruction IMG. Accordingly, the data processing device 100B(2) can produce image data VIDEO on the basis of the display instruction supplied by the data processing device 100B(1) and/or the positional relation to the data processing device 100B(1). As a result, a highly browsable data processing system or a highly portable data processing system can be provided.

Structures that can be applied to the first data processing device 100B are described with reference to FIGS. 9A1 and 9A2. Note that in FIG. 9A2, the first data processing device 100B illustrated in FIG. 9A1 is inverted.

The structure of the first data processing device 100B can be applied to the data processing device 100B(1) or the data processing device 100B(2) of the data processing system 200C.

The structure of the first data processing device 100B is the same as the structure of the data processing device 100 described in Embodiment 1 or 2 except that the first data processing device 100B is provided with the sign 129. Specifically, the first data processing device 100B includes an arithmetic device and an input/output device that are not illustrated.

<<Data Processing Device Provided with Sign>>

The first data processing device 100B of the data processing system 200B described in this embodiment is provided with the sign 129 along the display unit 122. Two sides of four sides surrounding the display unit 122 are provided with the sign 129. Specifically, one side (e.g., long side) of the two sides is provided with a light-emitting element group 129Y including first to fiftieth light-emitting elements, and the other side (e.g., short side) adjacent to the one side is provided with a light-emitting element group 129X including fifty-first to eightieth light-emitting elements (see FIG. 9A1).

In addition, the first data processing device 100B is provided with sensors of the position-measuring unit 124 along the display unit 122. The other two sides of the four sides surrounding the display unit 122, which are not provided with the sign 129, are provided with the sensors. Specifically, one side (e.g., long side) of the two sides is provided with a sensor 124Y including first to fiftieth photoelectric conversion elements, and the other side (e.g., short side) adjacent to the one side is provided with a sensor 124X including fifty-first to eightieth photoelectric conversion elements (see FIG. 9A2).

Note that the combination of the sign 129 and the sensors of the position-measuring unit 124 is not limited to the combination of the light-emitting elements and the photoelectric conversion elements as long as the position of the sign 129 can be measured.

The data processing device 100B(2) of the data processing system 200C includes the sensor 124Y and the sensor 124X around a display unit 122(2), and the positions of the light-emitting element group 129Y or the light-emitting element group 129X around a display unit 122(1) of the data processing device 100B(i) can be measured with the sensor 124Y or the sensor 124X (see FIG. 8B and FIGS. 9A1 and 9A2).

Thus, the positions of the display unit 122(1) and the display unit 122(2) can be measured accurately. As a result, image data VIDEO can be corrected in order to prevent a misaligned image from being displayed on the display unit 122(2) that is misaligned with the display unit 122(1).

<<Modification Example of Data Processing Device Provided with Sign>>

The data processing device 100D that is described as an example in the modification example in this embodiment and can be used for the data processing system 200B and the data processing system 200C includes a display element group 129W functioning as the sign 129 and a sensor 124W of the position-measuring unit 124 along a display unit 122D. Specifically, four sides surrounding the display unit 122D are provided with the display element groups 129W including light-emitting elements and the sensors 124W including photoelectric conversion elements (see FIG. 9B).

Examples of the display element group 129W are an organic electroluminescent element, a liquid crystal element, and electronic ink.

An example of the sensor 124W is a photodiode.

The positions of the display element group 129W and the sensor 124W are not particularly limited as long as the position of one data processing device 100D can measured by another data processing device 100D. For example, one sensor may be placed for a plurality of display elements.

Note that the display element group 129W and/or the sensor 124W of the data processing device 100D may have the same structure as the display unit 122. For example, a flexible optical touch panel is used for the display unit 122D and a region outside the display unit 122D, and a portion of the touch panel extending outside the display unit 122D is bent to be used for the display element group 129W and the sensor 124W.

A structure of the flexible touch panel is specifically described in Embodiment

### <<Example of Display>>

Operations of the data processing system 200C that displays image data are described with reference to FIGS. 10A and 10B and FIGS. 11A to 11C.

The data processing device 100B(1) is provided with the sign 129(1). The data processing device 100B(2) is provided with the sign 129(2).

In the case where the data processing device 100B(2) cannot measure the position of the sign 129(1) (e.g., the case where the data processing device 100B(2) is away from the sign 129(1)), the data processing device 100B(2) operates independently of the data processing device 100B(1) (see FIG. 10A).

In the case the data processing device 100B(2) measures the position of the sign 129(1) and obtains position data, the data processing device 100B(2) produces image data on the basis of a display instruction IMG and the position data and displays image data VIDEO on the display unit 122(2). Thus, the image data VIDEO is displayed across the display unit 122(1) of the data processing device 100B(1) and the display unit 122(2) of the data processing device 100B(2) (see FIG. 10B).

In the case where the data processing device 100B(2) is moved along the sign 129(1) of the data processing device 100B(1), the data processing device 100B(2) produces the image data VIDEO on the basis of the position data and displays the image data VIDEO on the display unit 122(2) (see FIG. 11A). Thus, the image data VIDEO to be displayed on the display unit 122(2) changes so that an image is displayed across the display unit 122(1) of the data processing device 100B(1) and the display unit 122(2) of the data processing device 100B(2).

In addition, also in the case where the data processing device 100B(2) is moved in the direction of a Z axis intersecting with the plane defined by the X axis and the Y axis, the data processing device 100B(2) produces image data on the basis of the position data and displays the image data on the display unit 122(2). For example, an image in the Z-axis direction (specifically, an image or the like in a cross section in the depth direction) may be displayed (see FIG. 11B). Note that the move distance in the Z-axis direction can be calculated by, for example, a sensing unit including an acceleration sensor.

In the case where the data processing device 100B(1) supplies, for example, a display instruction IMG to move the image data VIDEO to the right with an input unit not illustrated, the data processing device 100B(2) produces image data VIDEO on the basis of the display instruction IMG and displays the image data VIDEO on the display unit 122(2). Thus, the image data VIDEO is displayed across the display unit 122(1) of the data processing device 100B(1) and the display unit 122(2) of the data processing device 100B(2) (see FIG. 11C).

This embodiment can be combined as appropriate with any of the other embodiments in this specification.

### Embodiment 5

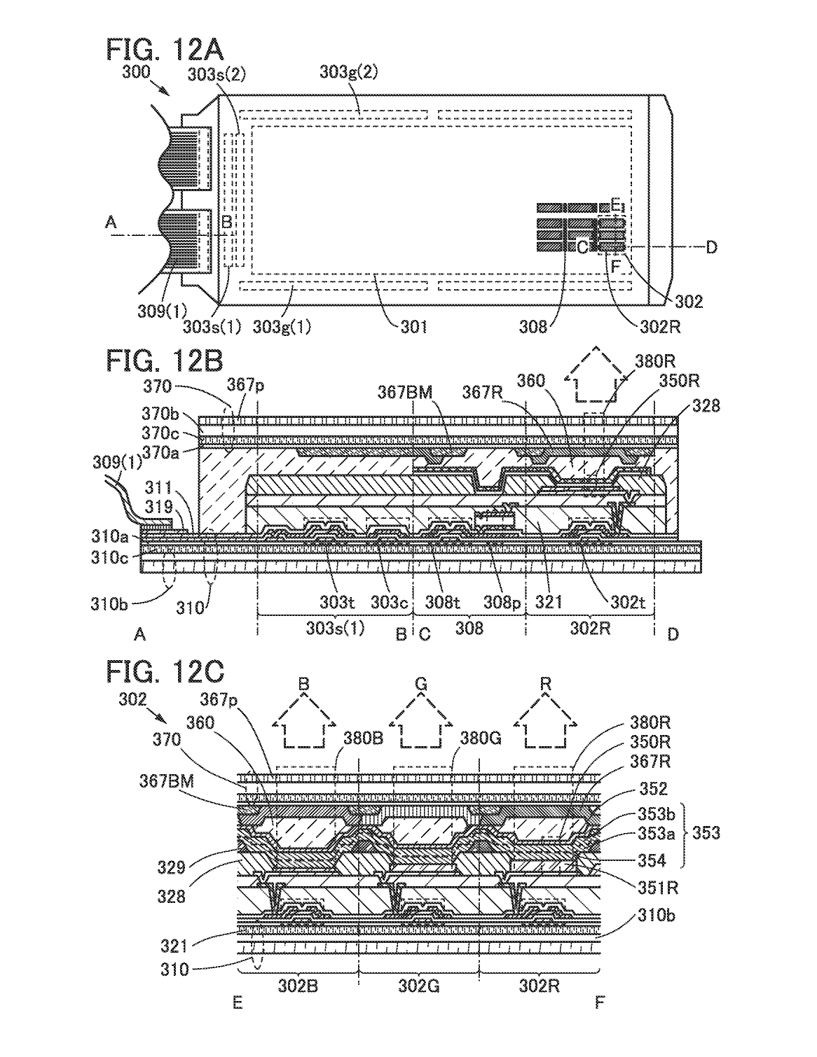

In this embodiment, a structure of an input/output device that can be used for the data processing device of one embodiment of the present invention is described with reference to FIGS. 12A to 12C.

FIG. 12A is a top view illustrating the structure of an input/output device that can be used for a data processing device of one embodiment of the present invention.

FIG. 12B is a cross-sectional view taken along line A-B and line C-D in FIG. 12A.

FIG. 12C is a cross-sectional view taken along line E-F in FIG. 12A.

### <Top View>

An input/output device 300 described as an example in this embodiment includes a display unit 301 (see FIG. 12A).

The display unit 301 includes a plurality of pixels 302 and a plurality of imaging pixels 308. The imaging pixels 308 can sense a touch of a finger or the like on the display unit 301. Thus, a touch sensor can be formed using the imaging pixels 308.

Each of the pixels 302 includes a plurality of sub-pixels (e.g., a sub-pixel 302R). In addition, in the sub-pixels, light-emitting elements and pixel circuits that can supply electric power for driving the light-emitting elements are provided.

The pixel circuits are electrically connected to wirings through which selection signals are supplied and wirings through which image signals are supplied.

Furthermore, the input/output device 300 is provided with a scan line driver circuit 303g(1) that can supply selection signals to the pixels 302 and an image signal line driver circuit 303s(1) that can supply image signals to the pixels 302.

The imaging pixels 308 include photoelectric conversion elements and imaging pixel circuits that drive the photoelectric conversion elements.

The imaging pixel circuits are electrically connected to wirings through which control signals are supplied and wirings through which power supply potentials are supplied.

Examples of the control signals include a signal for selecting an imaging pixel circuit from which a recorded imaging signal is read, a signal for initializing an imaging pixel circuit, and a signal for determining the time it takes for an imaging pixel circuit to detect light.

The input/output device 300 is provided with an imaging pixel driver circuit 303g(2) that can supply control signals to the imaging pixels 308 and an imaging signal line driver circuit 303s(2) that reads out imaging signals.

### <Cross-Sectional View>

The input/output device 300 includes a substrate 310 and a counter substrate 370 that faces the substrate 310 (see FIG. 12B).

The substrate 310 is a stacked body in which a flexible substrate 310b, a barrier film 310a that prevents diffusion of unintentional impurities to the light-emitting elements, and an adhesive layer 310c that attaches the barrier film 3100a to the substrate 310b are stacked.

The counter substrate 370 is a stacked body including a flexible substrate 370b, a barrier film 370a that prevents diffusion of unintentional impurities to the light-emitting elements, and an adhesive layer 370c that attaches the barrier film 370a to the substrate 370b (see FIG. 12B).

A sealant 360 attaches the counter substrate 370 to the substrate 310. The sealant 360, also serving as an optical adhesive layer, has a refractive index higher than that of air. The pixel circuits and the light-emitting elements (e.g., a first light-emitting element 350R) are provided between the substrate 310 and the counter substrate 370.

### <<Structure of Pixel>>

Each of the pixels 302 includes a sub-pixel 3021R a sub-pixel 302G, and a sub-pixel 302B (see FIG. 12C). The sub-pixel 302R includes a light-emitting module 380R, the sub-pixel 302G includes a light-emitting module 380G, and the sub-pixel 302B includes a light-emitting module 380B.

For example, the sub-pixel 302R includes the first light-emitting element 350R and the pixel circuit that can supply electric power to the first light-emitting element 350R and includes a transistor 302t (see FIG. 12B). Furthermore, the light-emitting module 380R includes the first light-emitting element 350R and an optical element (e.g., a first coloring layer 367R).

The first light-emitting element 350R includes a first lower electrode 351R, an upper electrode 352, and a layer 353 containing a light-emitting organic compound between the first lower electrode 351R and the upper electrode 352 (see FIG. 12C).

The layer 353 containing a light-emitting organic compound includes a light-emitting unit 353a, a light-emitting unit 353b, and an intermediate layer 354 between the light-emitting units 353a and 353b.

The light-emitting module 380R includes the first coloring layer 367R on the counter substrate 370. The coloring layer transmits light of a particular wavelength and is, for example, a layer that selectively transmits light of red, green, or blue color. A region that transmits light emitted from the light-emitting element as it is may be provided as well.

The light-emitting module 380R includes, for example, the sealant 360 that is in contact with the first light-emitting element 350R and the first coloring layer 367R.

The first coloring layer 367R is positioned in a region overlapping with the first light-emitting element 350R. Accordingly, part of light emitted from the first light-emitting element 350R passes through the sealant 360 that also serves as an optical adhesive layer and through the first coloring layer 367R and is emitted to the outside of the light-emitting module 380R as indicated by arrows in FIGS. 12B and 12C.

### <<Structure of Display Panel>>

The input/output device 300 includes a light-blocking layer 367BM on the counter substrate 370. The light-blocking layer 367BM is provided so as to surround the coloring layer (e.g., the first coloring layer 367R).

The input/output device 300 includes an anti-reflective layer 367p positioned in a region overlapping with the display unit 301. As the anti-reflective layer 367p, for example, a circular polarizing plate can be used.

The input/output device 300 includes an insulating film 321. The insulating film 321 covers the transistor 302t. Note that the insulating film 321 can be used as a layer for planarizing unevenness caused by the pixel circuits. An insulating film on which a layer that can prevent diffusion of impurities to the transistor 302t and the like is stacked can be used as the insulating film 321.

The input/output device 300 includes the light-emitting elements (e.g., the first light-emitting element 350R) over the insulating film 321.

The input/output device 300 includes, over the insulating film 321, a partition wall 328 that overlaps with an end portion of the first lower electrode 351R (see FIG. 12C). In addition, a spacer 329 that controls the distance between the substrate 310 and the counter substrate 370 is provided on the partition wall 328.

### <<Structure of Image Signal Line Driver Circuit>>

The image signal line driver circuit 303s(1) includes a transistor 303t and a capacitor 303c. Note that the driver circuit can be formed in the same process and over the same substrate as those of the pixel circuits.

### <<Structure of Imaging Pixel>>

The imaging pixels 308 each include a photoelectric conversion element 308p and an imaging pixel circuit for sensing light received by the photoelectric conversion element 308p. The imaging pixel circuit includes a transistor 308t.

For example, a PIN photodiode can be used as the photoelectric conversion element 308p.

### <<Other Structures>>

The input/output device 300 includes a wiring 311 through which a signal can be supplied. The wiring 311 is provided with a terminal 319. Note that an FPC 309(1) through which a signal such as an image signal or a synchronization signal can be supplied is electrically connected to the terminal 319.

Note that a printed wiring board (PWB) may be attached to the FPC 309(1).

This embodiment can be combined as appropriate with any of the other embodiments in this specification.

### Embodiment 6

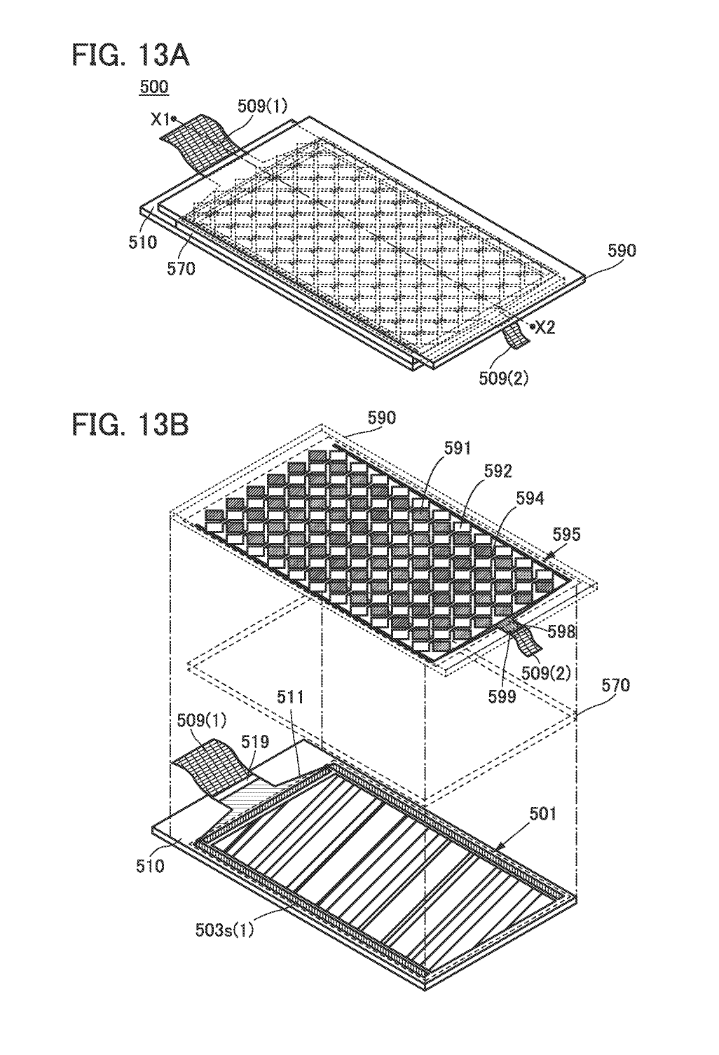

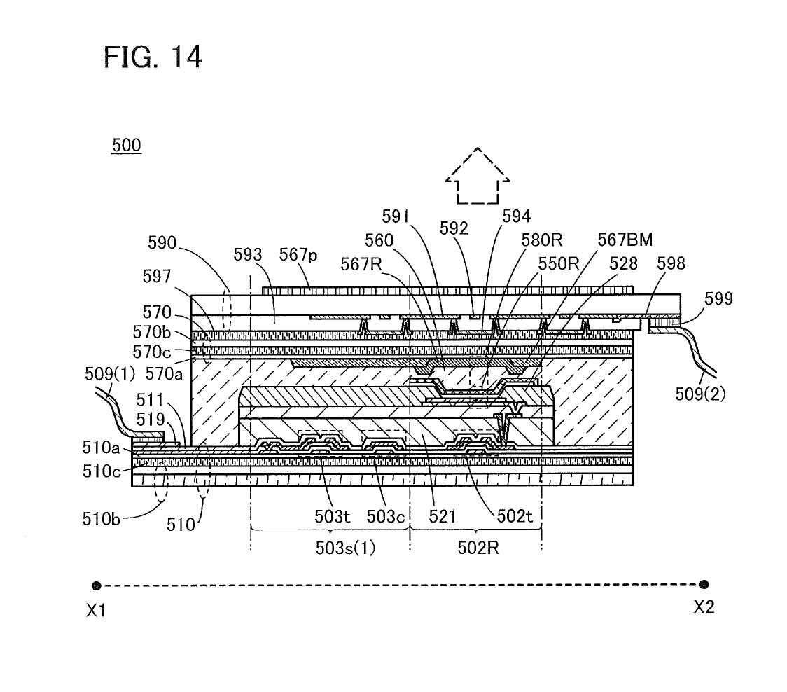

In this embodiment, a structure of a foldable touch panel in which a touch sensor (a contact sensor device) as an input unit is provided to overlap with a display unit is described with reference to FIGS. 13A and 13B and FIG. 14.

FIG. 13A is a schematic perspective view of a touch panel 500 described as an example in this embodiment. Note that FIGS. 13A and 13B illustrate only main components for simplicity. FIG. 13B is a developed view of the schematic perspective view of the touch panel 500.

FIG. 14 is a cross-sectional view of the touch panel 500 taken along line X1-X2 in FIG. 13A.

The touch panel 500 includes a display unit 501 and a touch sensor 595 (see FIG. 13B). Furthermore, the touch panel 500 includes a substrate 510, a substrate 570, and a substrate 590. Note that the substrate 510, the substrate 570, and the substrate 590 each have flexibility.

The display unit 501 includes the substrate 510, and over the substrate 510, a plurality of pixels and a plurality of wirings 511 through which signals are supplied to the pixels. The plurality of wirings 511 are led to a peripheral portion of the substrate 510, and some of the plurality of wirings 511 form a terminal 519. The terminal 519 is electrically connected to an FPC 509(1).

### <Touch Sensor>

The substrate 590 includes the touch sensor 595 and a plurality of wirings 598 electrically connected to the touch sensor 595. The plurality of wirings 598 are led to the periphery of the substrate 590, and some of the wirings 598 form part of a terminal for electrical connection to an FPC 509(2). Note that in FIG. 13B, electrodes, wirings, and the like of the touch sensor 595 that are provided on the back side of the substrate 590 (the side opposite to the viewer side) are indicated by solid lines for clarity.

A capacitive touch sensor is preferably used. Examples of the capacitive touch sensor are a surface capacitive touch sensor and a projected capacitive touch sensor. Examples of the projected capacitive touch sensor are a self-capacitive touch sensor and a mutual capacitive touch sensor, which differ mainly in the driving method. Examples of the projected capacitive touch sensor are a self-capacitive touch sensor and a mutual capacitive touch sensor, which differ mainly in the driving method. The use of a mutual capacitive touch sensor is preferable because multiple points can be sensed simultaneously.

An example of using a projected capacitive touch sensor is described below with reference to FIG. 13B. Note that a variety of sensors that can sense the closeness or the contact of a sensing target such as a finger can be used.

The projected capacitive touch sensor 595 includes electrodes 591 and electrodes 592. The electrodes 591 are electrically connected to any of the plurality of wirings 598, and the electrodes 592 are electrically connected to any of the other wirings 598.

The electrode 592 is in the form of a series of quadrangles arranged in one direction as illustrated in FIGS. 13A and 13B. Each of the electrodes 591 is in the form of a quadrangle. A wiring 594 electrically connects two electrodes 591 arranged in a direction intersecting with the direction in which the electrode 592 extends. The intersecting area of the electrode 592 and the wiring 594 is preferably as small as possible. Such a structure allows a reduction in the area of a region where the electrodes are not provided, so that unevenness in transmittance can be reduced. As a result, unevenness in luminance of light from the touch sensor 595 can be reduced.

Note that the shapes of the electrodes 591 and the electrodes 592 are not limited to the above-mentioned shapes and can be any of a variety of shapes. For example, the plurality of electrodes 591 may be provided so that space between the electrodes 591 are reduced as much as possible, and a plurality of electrodes 592 may be provided with an insulating layer sandwiched between the electrodes 591 and the electrodes 592 and may be spaced apart from each other to form a region not overlapping with the electrodes 591. In that case, a dummy electrode electrically insulated from these electrodes are preferably provided between two adjacent electrodes 592, in which case the area of regions having different transmittances can be reduced.

The structure of the touch sensor 595 is described with reference to FIG. 14.

The touch sensor 595 includes the substrate 590, the electrodes 591 and the electrodes 592 provided in a staggered arrangement on the substrate 590, an insulating layer 593 covering the electrodes 591 and the electrodes 592, and the wiring 594 that electrically connects the adjacent electrodes 591 to each other.

An adhesive layer 597 attaches the substrate 590 to the substrate 570 so that the touch sensor 595 overlaps with the display unit 501

The electrodes 591 and the electrodes 592 are formed using a light-transmitting conductive material. As a light-transmitting conductive material, a conductive oxide such as indium oxide, indium tin oxide, indium zinc oxide, zinc oxide, or zinc oxide to which gallium is added can be used.

The electrodes 591 and the electrodes 592 may be formed by depositing a light-transmitting conductive material on the substrate 590 by a sputtering method and then removing an unnecessary portion by any of known patterning techniques such as photolithography.

The insulating layer 593 covers the electrodes 591 and the electrodes 592. Examples of a material for the insulating layer 593 are a resin such as acrylic or epoxy resin, a resin having a siloxane bond, and an inorganic insulating material such as silicon oxide, silicon oxynitride, or aluminum oxide.

Furthermore, openings reaching the electrodes 591 are formed in the insulating layer 593, and the wiring 594 electrically connects the adjacent electrodes 591. The wiring 594 is preferably formed using a light-transmitting conductive material, in which case the aperture ratio of the touch panel can be increased. Moreover, the wiring 594 is preferably formed using a material that has higher conductivity than those of the electrodes 591 and the electrodes 592.

One electrode 592 extends in one direction, and a plurality of electrodes 592 are provided in the form of stripes.

The wiring 594 intersects with the electrode 592.

Adjacent electrodes 591 are provided with one electrode 592 provided therebetween and are electrically connected by the wiring 594.

Note that the plurality of electrodes 591 are not necessarily arranged in the direction orthogonal to one electrode 592 and may be arranged to intersect with one electrode 592 at an angle of less than 90 degrees.

One wiring 598 is electrically connected to any of the electrodes 591 and 592. Part of the wiring 598 functions as a terminal. For the wiring 598, a metal material such as aluminum, gold, platinum, silver, nickel, titanium, tungsten, chromium, molybdenum, iron, cobalt, copper, or palladium or an alloy material containing any of these metal materials can be used.

Note that an insulating layer that covers the insulating layer 593 and the wiring 594 may be provided to protect the touch sensor 595.

Furthermore, a connection layer 599 electrically connects the wiring 598 to the FPC 509(2).

As the connection layer 599, a known anisotropic conductive film (ACF), a known anisotropic conductive paste (ACP), or the like can be used.

The adhesive layer 597 has a light-transmitting property. For example, a thermosetting resin or an ultraviolet curable resin can be used; specifically, a resin such as acrylic, urethane, epoxy resin, or a resin having a siloxane bond can be used.

### <Display Unit>

The display unit 501 includes a plurality of pixels arranged in a matrix. Each of the pixels includes a display element and a pixel circuit for driving the display element.

In this embodiment, an example of using an organic electroluminescent element that emits white light as a display element will be described; however, the display element is not limited to such element.

As the display element, for example, in addition to organic electroluminescent elements, any of a variety of display elements such as display elements (electronic ink) that perform display by an electrophoretic method, an electronic liquid powder method, or the like; MEMS shutter display elements: and optical interference type MEMS display elements can be used. Note that a pixel circuit structure suitable for display elements to be used can be selected from known pixel circuit structures.

The substrate 510 is a stacked body in which a flexible substrate 510b, a barrier film 510a that prevents diffusion of unintentional impurities to light-emitting elements, and an adhesive layer 510e that attaches the barrier film 510a to the substrate 510b are stacked.

The substrate 570 is a stacked body in which a flexible substrate 570b, a barrier film 570a that prevents diffusion of unintentional impurities to the light-emitting elements, and an adhesive layer 570c that attaches the barrier film 570a to the substrate 570b are stacked.

A sealant 560 attaches the substrate 570 to the substrate 510. The sealant 560, also serving as an optical adhesive layer, has a refractive index higher than that of air. The pixel circuits and the light-emitting elements (e.g., a first light-emitting element 550R) are provided between the substrate 510 and the substrate 570.

### <<Structure of Pixel>>

A pixel includes a sub-pixel 502R, and the sub-pixel 502R includes a light-emitting module 580R.

The sub-pixel 502R includes the first light-emitting element 550R and the pixel circuit that can supply electric power to the first light-emitting element 550R and includes a transistor 502t. Furthermore, the light-emitting module 580R includes the first light-emitting element 550R and an optical element (e.g., a first coloring layer 567R).

The first light-emitting element 550R includes a lower electrode, an upper electrode, and a layer containing a light-emitting organic compound between the lower electrode and the upper electrode.

The light-emitting module 580R includes the first coloring layer 567R on the substrate 570. The coloring layer transmits light of a particular wavelength and is, for example, a layer that selectively transmits light of red, green, or blue color. A region that transmits light emitted from the light-emitting element as it is may be provided as well.

The light-emitting module 580R includes the sealant 560 that is in contact with the first light-emitting element 550R and the first coloring layer 567R.

The first coloring layer 567R is positioned in a region overlapping with the first light-emitting element 550R. Accordingly, part of light emitted from the first light-emitting element 550R passes through the sealant 560 that also serves as an optical adhesive layer and through the first coloring layer 567R and is emitted to the outside of the light-emitting module 580R as indicated by an arrow in FIG. 14.

### <<Structure of Display Unit>>

The display unit 501 includes a light-blocking layer 567BM on the substrate 570. The light-blocking layer 567BM is provided so as to surround the coloring layer (e.g., the first coloring layer 567R).

The display unit 501 includes an anti-reflective layer 567p positioned in a region overlapping with pixels. As the anti-reflective layer 567p, for example, a circular polarizing plate can be used.

The display unit 501 includes an insulating film 521. The insulating film 521 covers the transistor 502t. Note that the insulating film 521 can be used as a layer for planarizing unevenness caused by the pixel circuits. An insulating film on which a layer that can prevent diffusion of impurities to the transistor 502t and the like is stacked can be used as the insulating film 521.

The display unit 501 includes the light-emitting elements (e.g., the first light-emitting element 550R) over the insulating film 521.

The display unit 501 includes, over the insulating film 521, a partition wall 528 that overlaps with an end portion of the lower electrode. In addition, a spacer that controls the distance between the substrate 510 and the substrate 570 is provided on the partition wall 528

### <<Structure of Image Signal Line Driver Circuit>>

The image signal line driver circuit 503s(1) includes a transistor 503t and a capacitor 503c. Note that the driver circuit can be formed in the same process and over the same substrate as those of the pixel circuits.

### <<Other Structures>>

The display unit 501 includes the wirings 511 through which signals can be supplied. The wirings 511 are provided with the terminal 519. Note that the FPC 509(1) through which a signal such as an image signal or a synchronization signal can be supplied is electrically connected to the terminal 519.

Note that a printed wiring board (PWB) may be attached to the FPC 509(1).

This embodiment can be combined as appropriate with any of the other embodiments in this specification.

This application is based on Japanese Patent Application serial no. 2013-146068 filed with the Japan Patent Office on Jul. 12, 2013, the entire contents of which are hereby incorporated by reference.

What is claimed is:

1. A data processing device comprising:
an input/output device comprising:
a communication unit;
a position-measuring unit; and
a display unit; and
an arithmetic device comprising:
an arithmetic unit; and
a storage unit configured to store a program to be executed by the arithmetic unit,
wherein:
the communication unit is configured to receive a display instruction,
the position-measuring unit is configured to measure a position of a sign and to produce position data,
the program is configured to produce image data on the basis of the display instruction and the position data supplied from the input/output device, and
the display unit is configured to display the image data supplied from the arithmetic device.

2. The data processing device according to claim 1, the program comprising the steps of:
a first step of performing initialization;
a second step of determining a first correction parameter on the basis of the position data;
a third step of producing the image data on the basis of the first correction parameter;
a fourth step of allowing interrupt processing;
a fifth step of displaying the image data;
a sixth step of proceeding to a seventh step in the case where a termination instruction has been supplied in the interrupt processing, whereas returning to the fifth step in the case where the termination instruction has not been supplied; and
the seventh step of terminating the program.

3. The data processing device according to claim 2, the interrupt processing comprising the steps of:
an eighth step of proceeding to a ninth step in the case where the display instruction has been supplied, whereas proceeding to a tenth step in the case where the display instruction has not been supplied;
the ninth step of producing the image data on the basis of the display instruction;
the tenth step of determining a second correction parameter on the basis of the position data;
an eleventh step of proceeding to a twelfth step in the case where the second correction parameter has changed from the first correction parameter, whereas proceeding to a thirteenth step in the case where the second correction parameter has not changed from the first correction parameter;
the twelfth step of producing the image data on the basis of the second correction parameter; and
the thirteenth step of recovering from the interrupt processing.

4. The data processing device according to claim 1, the position-measuring unit comprising:
a sensor placed along the display unit and supplying a sensing signal; and
a sensing signal processing circuit processing the sensing signal.

5. The data processing device according to claim 1, the position-measuring unit comprising:
an imaging sensor placed along the display unit; and
an image processing circuit,
wherein the image processing circuit executes:
a first step of performing initialization;
a second step of capturing a sign image by the imaging sensor;
a third step of binarizing the sign image to generate a binary image;
a fourth step of proceeding to a fifth step in the case where the binary image has a predetermined pattern, whereas proceeding to a sixth step in the case where the binary image does not have the predetermined pattern;
the fifth step of producing position data of the sign by identification from coordinates of the predetermined pattern in the binary image; and
the sixth step of returning to the first step.

6. The data processing device according to claim 1, wherein the display unit comprises a light-emitting element comprising a light-emitting organic compound.

7. A data processing system comprising:
a sign;
a first data processing device comprising a first input/output device; and
a second data processing device comprising a second input/output device and an arithmetic device,
wherein:
the first input/output device comprises:
a first position-measuring unit; and
a first communication unit;
the second input/output device comprises:
a second communication unit;
a second position-measuring unit; and
a display unit,
the arithmetic device comprises:
an arithmetic unit; and
a storage unit configured to store a program to be executed by the arithmetic unit,
the first position-measuring unit is configured to measure a position of the sign and to produce and supply a first position data,
the first communication unit is configured to supply a display instruction and the first position data to the second input/output device,
the second communication unit is configured to receive the display instruction and the first position data supplied from the first input/output device,
the second position-measuring unit is configured to measure a position of the sign and to produce and supply a second position data,
the program is configured to produce image data on the basis of the display instruction, the first position data, and the second position data, and
the display unit is configured to display the image data supplied from the arithmetic device.

8. The data processing system according to claim 7, the program comprising the steps of:
a first step of performing initialization;
a second step of determining a first correction parameter on the basis of the first position data and the second position data;
a third step of producing the image data on the basis of the first correction parameter;
a fourth step of allowing interrupt processing;
a fifth step of displaying the image data;
a sixth step of proceeding to a seventh step in the case where a termination instruction has been supplied in the interrupt processing, whereas returning to the fifth step in the case where the termination instruction has not been supplied; and
the seventh step of terminating the program.

9. The data processing system according to claim 8, the interrupt processing comprising the steps of:
an eighth step of proceeding to a ninth step in the case where the display instruction has been supplied, whereas proceeding to a tenth step in the case where the display instruction has not been supplied;
the ninth step of producing the image data on the basis of the display instruction;
the tenth step of determining a second correction parameter on the basis of the first position data and the second position data;
an eleventh step of proceeding to a twelfth step in the case where the second correction parameter has changed from the first correction parameter, whereas proceeding to a thirteenth step in the case where the second correction parameter has not changed from the first correction parameter;
the twelfth step of producing the image data on the basis of the second correction parameter; and
the thirteenth step of recovering from the interrupt processing.

10. The data processing system according to claim 7, wherein the first data processing device comprises the sign.

11. The data processing system according to claim 7, each of the first position-measuring unit and the second position-measuring unit comprising:
a sensor placed along the display unit and supplying a sensing signal; and
a sensing signal processing circuit processing the sensing signal.

12. The data processing system according to claim 7, each of the first position-measuring unit and the second position-measuring unit comprising:
an imaging sensor placed along the display unit; and
an image processing circuit,
wherein the image processing circuit executes:
a first step of performing initialization;
a second step of capturing a sign image by the imaging sensor;
a third step of binarizing the sign image to generate a binary image;
a fourth step of proceeding to a fifth step in the case where the binary image has a predetermined pattern, whereas proceeding to a sixth step in the case where the binary image does not have the predetermined pattern;
the fifth step of producing position data of the sign by identification from coordinates of the predetermined pattern in the binary image; and
the sixth step of returning to the first step.

13. The data processing system according to claim 7, wherein the display unit comprises a light-emitting element comprising a light-emitting organic compound.
